(19) United States
(12) Patent Application Publication
(10) Pub. No.: US 2015/0115761 A1
(43) Pub. Date: Apr. 30, 2015

(54) ELECTRO-HYDRAULIC DEVICE COMPRISING A THREE-PHASE ASYNCHRONOUS MOTOR FOR MOVING A JIB

(71) Applicants: Ulrich Dorzbach, Heilbronn (DE); Andreas Wagner, Talheim (DE)

(72) Inventors: Ulrich Dorzbach, Heilbronn (DE); Andreas Wagner, Talheim (DE)

(73) Assignee: WOLFFKRAN HOLDING AG, Zug (CH)

(21) Appl. No.: 14/403,410

(22) PCT Filed: Apr. 16, 2013
(86) PCT No.: PCT/EP2013/057910

§ 371 Date: Nov. 24, 2014

(30) Foreign Application Priority Data
May 31, 2012 (DE) 10 2012 010 760.9

(51) Int. Cl. B66C 23/82; H02K 17/02

(52) U.S. Cl. CPC B66C 23/82; H02K 17/02
USPC 310/166

(57) ABSTRACT

The invention relates to an electro-hydraulic device for moving a jib for a derricking-jib tower crane, the motor of said device being designed for operation at the average required power. The operating time in an energy-wasting part load range is thus significantly reduced in relation to conventional electro-hydraulic devices for moving a jib.

The invention relates to an electro-hydraulic device for moving a jib of a luffing jib tower crane, and to a luffing jib tower crane with an electro-hydraulic device of this type.

Electro-hydraulic devices for moving the jib of a luffing jib tower crane are known. They comprise a hydraulic assembly and a hydraulic cylinder.

A hydraulic assembly usually comprises an oil tank, a pump, an electric motor (usually a three-phase asynchronous motor), valves for changing the direction, an adjustable valve for setting various working speeds, and a hydraulic power regulator. The hydraulic assembly makes oil available at the hydraulic cylinder in the quantity which is required for moving the load jib and at the required pressure. If the hydraulic cylinder is to be retracted or extended, this means a change in the pressure which is required at the hydraulic cylinder. The oil flow is controlled depending on the required pressure.

The maximum power output of the electro-hydraulic device is required if the luffing jib is to be “luffed inward”, that is to say is to be moved inward toward the tower and upward, at maximum overhang with a maximum load capacity.

In conventional electro-hydraulic devices for jib movement, the motor is designed for the respectively required maximum power output. This means, however, that the motor operates in the energy-wasting part load range most of the time. Three-phase asynchronous motors, for example, have their lowest losses at the nominal operating point.

It is an object of the invention to provide an electro-hydraulic device for moving a jib of a luffing jib tower crane, which is less expensive and operates more economically in terms of energy than conventional systems.

The object is achieved by way of the subject matter of patent claim 1 and by way of a luffing jib tower crane as claimed in patent claim 3.

It has now been shown surprisingly that, in the electro-hydraulic devices for jib movement in luffing jib tower cranes, a design of the hydraulic power regulation which is oriented toward the maximum power output can be dispensed with if the motor is a three-phase asynchronous motor and the three-phase asynchronous motor is designed at least toward the medium required power output. This solution is possible, since the luffing gear operates on average for only approximately 40% of the “working time”. In addition, the maximum load capacity is actually moved only rarely. The change in the position of the luffing jib from the maximum overhang to the minimum overhang usually does not take longer than 90 seconds. The motor therefore always has sufficient time to cool down again. During this change of the position of the jib in the inward direction (“luffing inward”), the overload decreases continuously.

Asynchronous motors can be overloaded. The following diagram shows how the required electrical power P changes in relation to the motor nominal power output depending on the overhang.

The occasional deliberate overloading which is associated with the solution according to the invention is possible, since the required torque and the torque curve of the motor are in each case known. All the other components are preferably designed for the higher torque.

Moreover, the motor is preferably protected by way of an over-temperature protection means.

1. An electro-hydraulic device for moving a jib of a luffing jib tower crane, the motor of the hydraulic assembly being a three-phase asynchronous motor, characterized in that the three-phase asynchronous motor is designed for a power output which lies between the maximum power output and approximately the medium required power output.

2. The electro-hydraulic device for moving a jib of a luffing jib tower crane as claimed in claim 1, characterized in that the three-phase asynchronous motor has an over-temperature protection means.

3. A luffing jib tower crane, comprising an electro-hydraulic device for moving a jib as claimed in claim 1 or 2.
